(19) United States
(12) Patent Application Publication
(10) Pub. No.: US 2006/0014920 A1
(43) Pub. Date: Jan. 19, 2006

(54) Polyester mutifilament yarn

(76) Inventors: Yoshiki Shirakawa, Ehime (JP); Keijiro Hattori, Ehime (JP); Hiroyuki Osaka, Ehime (JP)

Correspondence Address: SUGHRUE MION, PLLC, 2100 PENNSYLVANIA AVENUE, N.W., SUITE 800, WASHINGTON, DC, 20037, US

(21) Appl. No.: 10/535,419

(22) PCT Filed: Feb. 23, 2004
(86) PCT No.: PCT/JP04/02084

§ 371 Date: May 19, 2005

(30) Foreign Application Priority Data
Mar. 20, 2003 (JP) 2003-077510

(51) Int. Cl. C08G 63/02

(52) U.S. Cl. 528/272

(57) ABSTRACT

A polyester multifilament yarn having an individual filament thickness of 0.3 to 2.0 dtex, a total thickness of 90 dtex or less and a silk factor of 22 or more, can be obtained from a polyester polymer produced by polycondensing an aromatic dicarboxylate ester in the presence of a catalyst which comprises a mixture of a Ti compound component (A) comprising at least one member selected from titanium alkoxides and reaction products of the titanium alkoxides with carboxylic acids or anhydrides thereof, with a specific P compound component (B), and/or a reaction product of the Ti compound component (A) for the mixture with a specific P compound component (D), the resultant yarn having a good color tone (a low b* value) and an excellent weaving or knitting property and a good dyeing processability.

### TECHNICAL FIELD

The present invention relates to a polyester multifilament yarn. More particularly, the present invention relates to a polyester multifilament yarn produced from a polyester resin having a good color tone and an excellent formability, and having a high resistance to fluff-generation, a good color tone and a high mechanical strength. The polyester multifilament yarn of the present invention is useful for forming a woven or knitted fabric having a good hand, a good appearance and a high mechanical strength.

### BACKGROUND ART

It is well known that polyester resins, particularly polyethylene terephthalate, polyethylene naphthalate, polytrimethylene terephthalate and polytetramethylene terephthalate have excellent mechanical, physical and chemical properties, and thus are widely utilized for fibers, films and other shaped articles. Particularly for use in knitted and woven fabrics, the polyester resin products are known to have excellent mechanical strength, dimensional stability, heat resistance and light resistance.

Currently, polyester fibers are being widely used due to the excellent light resistance thereof, as high strength fibers, particularly in the fields of outdoor sport clothes and industrial clothes, in place of conventional polyamide fibers such as nylon 6 and nylon 66 fibers. The outdoor sport clothes and industrial clothes produced from fabrics including multifilament yarns comprising the above-mentioned high strength fibers are required to have a good hand in combination with the high mechanical strength. Accordingly, multifilament yarns having a small thickness, a high mechanical strength, an appropriate elongation, and thus enabling the resultant fabric from the yarns to have a low thickness and a high compactibility, have been needed.

Each of the above-mentioned polymers for fibers, for example polyethylene terephthalate, is usually produced by, for example, preparing a ethylene glycol ester of terephthalic acid and/or an oligomer thereof, and then polycondensation-reacting the ester monomer or oligomer in the presence of a polycondensation catalyst under a reduced pressure while heating the reaction system until a desired degree of polymerization of the resultant polyester resin is attained. Other polyesters can be produced by procedures similar to the above-mentioned procedure.

With respect to the procedure, it is well known that the quality of the resultant polyester resin is greatly influenced by the type of the polycondensation catalyst and, as a polycondensation catalyst for polyethylene terephthalate, antimony compounds are most widely employed.

However, when an antimony compound is used as the polycondensation catalyst, there arises the following problem. That is, when the resulting polyester is continuously melt-spun for a long time, around a spinneret for melt spinning, foreign matter (hereinafter sometimes referred to as spinneret foreign matter) is deposited thereby to cause a bending phenomenon of a molten polymer stream extruded through the spinneret, which leads to the occurrence of fuzzing and/or breakage of fibers or yarns or to the unevenness in performance of the fibers or yarns during the spinning step and/or the drawing step. Particularly, in the production of filaments usable for outdoor and industrial material fields and required to have a high mechanical strength and a small thickness, it is very important to solve the above-mentioned problem.

To solve the problem, it is known to use a titanium compound, for example, titanium tetrabutoxide as a polycondensation catalyst. In this case, however, the resultant polyester polymer exhibits a low thermal stability and, when melted, the polymer is significantly deteriorated. Therefore the production of polyester filaments having high mechanical strengths is difficult. Also, there arises a problem that the resultant polyester polymer is colored yellow, and the resultant fibers exhibit an unsatisfactory color tone.

As means for solving the problem, it is disclosed in, for example, Japanese Examined Patent Publication No. 59-46258 (Patent Document 1), that a product obtained by reacting a titanium compound with trimellitic acid is used as a catalyst for preparation of a polyester, and in, for example, Japanese Unexamined Patent Publication No. 58-38722 (Patent Document 2), that a product obtained by reacting a titanium compound with a phosphite ester is used as a catalyst for producing a polyester. Although the thermal stability of the melt of the polyester is certainly improved to some extent by this processes, the degree of improvement is insufficient and the resulting polyesters have insufficient color tone. Therefore, a further improvement in the color tone of the polyester is required. Furthermore, Japanese Unexamined Patent Publication (Kokai) No. 7-138354 (Patent Document 3) proposes use of a complex of a titanium compound with a phosphorus compound as a catalyst for the preparation of a polyester. Although this process enables the thermal stability of the melt of the polyester to be improved to some extent, this process has the problem that the degree of improvement is still insufficient and that the color tone of the resulting polyester must be further improved.
[Patent Document 1] Japanese Examined Patent Publication No. 59-46258
[Patent Document 2] Japanese Unexamined Patent Publication No. 58-38722
[Patent Document 3] Japanese Unexamined Patent Publication (Kokai) No. 7-138354

### DISCLOSURE OF THE INVENTION

An object of the present invention is to provide a polyester multifilament yarn having a low thickness, good color tone (a high L* value and a low b* value) and a good hand and capable of exhibiting, when the yarn is converted to a woven or knitted fabric usable for sport clothes, a sufficient mechanical strength, a high resistance to fuzzing and a good color tone.

The polyester multifilament yarn of the present invention comprises, as a principal component, a polyester polymer produced by polycondensing an aromatic dicarboxylate ester in the presence of a catalyst,
wherein
the catalyst comprises at least one member selected from mixtures (1) and reaction products (2);
the mixtures (1) for the catalyst comprises a titanium compound component (A) mixed with phosphorus compound component (B),
in which mixtures (1),
the component (A) comprises at least one member selected from the group consisting of (a) titanium alkoxides represented by the general formula (I): 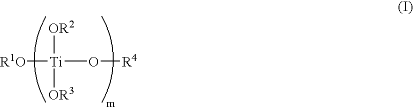
   in which formula (I), R¹, R², R³ and R⁴ respectively and independently from each other represent a member selected from alkyl groups having 1 to 20 carbon atoms and a phenyl group, m represent an integer of 1 to 4, and when m represents an integer of 2, 3 or 4, the 2, 3 or 4 R²s and R³s may be respectively the same as each other or different from each other, and (b) reaction products of the titanium compounds of the general formula (I) with aromatic polycarboxylic acids represented by the formula (II): 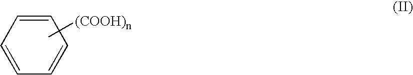
   in which formula (II), n represents an integer of 2 to 4, or anhydrides of the acids of the formula (II); and
the component (B) comprises at least one phosphorus compound represented by the general formula (III): 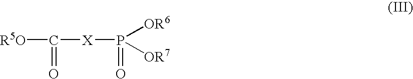
   in which formula (III), R⁵, R⁶ and R⁷ respectively and independently from each other represent an alkyl group having 1 to 4 carbon atoms, X represents a member selected from a —CH₂— group and a —CH(Y)— group (wherein Y represents a phenyl group),
the mixture (1) for the catalyst for the polycondensation being employed in an amount satisfying the requirements represented by the following expressions of relation (i) and (ii):
   1≦Mₚ/M_{Ti}≦15 (i)
   and
   10≦Mₚ+M_{Ti}≦100 (ii)
   wherein M_{Ti} represents a ratio in % of a value in millimoles of titanium element contained in the titanium compound component (A) to a value in moles of the aromatic dicarboxylate ester, and Mₚ represents a ratio in % of a value in millimoles of phosphorus element contained in the phosphorus compound component (A) to the value in moles of the aromatic dicarboxylate ester,
the reaction products (2) for the catalyst comprises a component (C) reacted with a component (D),
in which reaction products (2),
the component (C) comprises at least one member selected from the group consisting of (c) titanium alkoxides represented by the general formula (I) and (d) reaction products of the titanium alkoxides of the general formula (I) with aromatic polycarboxylic acids represented by the above-mentioned general formula (II) or anhydrode of the acids; and
the component (D) comprises at least one phosphorus compound represented by the general formula (IV): 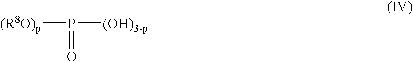
   in which formula (IV), R⁸ represents an alkyl group having 1 to 20 carbon atoms or any aryl group having 6 to 20 carbon atoms, and p represents an integer of 1 or 2, and
the multifilament yarn has a thickness of individual filaments of 0.3 to 2.0 dtex, a total thickness of the yarn of 90 dtex or less, and a silk factor (S.F.) value of 22 or more, determined in accordance with the following equation (1):
   (S.F.)=(Tensile strength)×(Ultimate elongation)^{1/2} (1).

In the polyester multifilament yarn of the present invention, in the component (A) of the mixture (1) for the catalyst, a reaction molar ratio of titanium alkoxide (a) to the aromatic polycarboxylic acid of the general formula (II) or the anhydride thereof is preferably in the range of from 2:1 to 2:5.

In the polyester multifilament yarn of the present invention, the dialkyl aromatic dicarboxylate ester is preferably one produced by a transesterification reaction of a dialkyl ester of an aromatic dicarboxylic acid with an alkylene glycol.

In the polyester multifilament yarn of the present invention, the aromatic dicarboxylic acid is preferably selected from terephthalic acid, 1,2-naphthalene dicarboxylic acid, phthalic acid, isophthalic acid, diphenyldicarboxylic acid, and diphenoxyethane dicarboxylic acid and the alkylene glycol is selected from ethylene glycol, butylene glycol, trimethylene glycol, propylene glycol, neopentyl glycol, hexamethylene glycol and dodecamethylene glycol.

In the polyester multifilament yarn of the present invention, the polyester is preferably a polyethylene terephthalate.

In the polyester multifilament yarn of the present invention, the polyester polymer preferably has an L* value of 60 to 90 and a b* value of 1 to 10, determined in accordance with the L*a*b* color specification of JIS Z 8729.

In the polyester multifilament yarn of the present invention may be in the form of a woven or knitted fabric.

### BEST MODE FOR CARRYING OUT THE INVENTION

The polyester multifilament yarn is constituted from polyester multifilaments comprising, as a principal component, a polyester polymer.

The polyester polymer is one produced by polycondensing an aromatic dicarboxylate ester in the presence of a catalyst. The catalyst for the polycondensation comprises at least one member selected from mixtures (1) of the titanium compound component (A) with the phosphorus compound component (B) and reaction products (2) of the titanium compound component (C) with the phosphorus compound component (D) as shown below.

The titanium compound component (A) for the mixture (1) for the polycondensation catalyst comprises at least one member selected from the group consisting of (a) titanium alkoxides represented by the general formula (I): 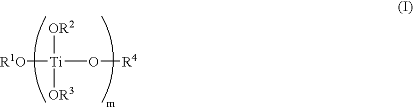
in which formula (I), R¹, R², R³ and R⁴ respectively and independently from each other represent a member selected from alkyl groups having 1 to 20 carbon atoms, preferably 1 to 6 carbon atoms and a phenyl group, m represent an integer of 1 to 4, preferably 2 to 4, and when m represents an integer of 2, 3 or 4, the 2, 3 or 4 R²s and R³s may be respectively the same as each other or different from each other, and (b) reaction products of the titanium compounds of the general formula (I) with aromatic polycarboxylic acids represented by the formula (II): 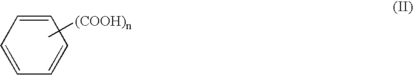
in which formula (II), n represents an integer of 2 to 4, preferably 3 to 4, or anhydrides of the acids of the formula (II).

The phosphorus compound component (B) of the mixture (1) for the polycondensation catalyst comprises at least one phosphorus compound represented by the general formula (III): 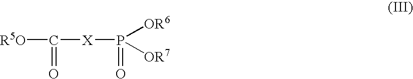
in which formula (III), R⁵, R⁶ and R⁷ respectively and independently from each other represent an alkyl group having 1 to 4 carbon atoms, X represents a member selected from a —CH₂— group and a —CH(Y)— group, wherein Y represents a phenyl group.

The titanium compound component (C) of the reaction products (2) for the polycondensation catalyst comprises at least one member selected from the group consisting of (c) titanium alkoxides represented by the general formula (I) and (d) reaction products of the titanium alkoxides of the general formula (I) with aromatic polycarboxylic acids represented by the above-mentioned general formula (II) or anhydrode of the acids.

The phosphorus compound component (D) of the reaction product (2) for the polycondensation catalyst comprises at least one phosphorus compound represented by the general formula (IV): 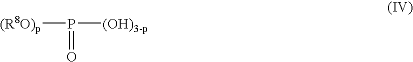
in which formula (IV), R⁸ represents an alkyl group having 1 to 20 carbon atoms or any aryl group having 6 to 20 carbon atoms, and p represents an integer of 1 or 2.

In the case where mixtures (1) of a titanium compound component (A) with a phosphorous compound component (B), or reaction products (2) of a titanium compound component (C) with a phosphorous compound component (D) are employed, as polycondensation catalysts, the titanium alkoxide (a) or (c) represented by the general formula (I) and usable for the titanium compound component (A) or (C), and the reaction product (b) or (d) of titanium alkoxide (a) or (c) with an aromatic polycarboxylic acid represented by the general formula (II) or with an anhydride thereof, have a high solubility in, or a high affinity to, the polyester polymer, and thus the catalyst comprising the mixture (1) or reaction product (2) exhibits a high solubility in or a high affinity to the polyester polymer. Therefore, the catalyst comprising the mixtures (1) or the reaction products (2) has a high solubility in, or a high affinity to, the polyester polymer, which solubility or affinity is sufficient in practice, and even if the mixture (1) or reaction product (2) for the catalyst remains in the polyester polymer produced by the polycondensation procedure, and the polyester polymer is melt-spun, no foreign matter is accumulated around the spinneret for melt spinning, and thus polyester filaments having a high quality can be produced with high melt-spinning efficiency.

The titanium alkoxides (a) of the general formula (I) usable for the titanium compound component (A) for the polycondensation catalyst and the titanium alkoxide compounds for the titanium compound component (C) are preferably selected from titanium tetraisopropoxide, titanium tetrapropoxide, titanium tetra-n-butoxide, titanium tetraethoxide, titanium tetraphenoxide, octaalkyl trititanates and hexaalkyl dititanates. Particularly, titanium tetrabutoxide, which has a high reactivity with the phosphorus compound component, is preferably used.

The aromatic polycarboxylic acids of the general formula (II) and the anhydrides thereof, to be reacted with the titanium alkoxides (a) for the titanium compound component (A) are preferably selected from phthalic acid, trimellitic acid, hemimellitic acid, pyromellitic acid and anhydrides of the above-mentioned acids. Particularly, when trimellitic anhydride is used, the resultant reaction product (b) exhibits a high affinity to the polyester polymer and thus contributes to preventing the accumulation of the foreign matter.

To react the titanium alkoxide (a) with the aromatic polycarboxylic acid of the general formula (II) or the anhydride thereof, preferably, the aromatic. polycarboxylic acids or the anhydrides thereof are dissolved in, for example, a solvent; to the resultant mixed liquid, a titanium alkoxides (a) is added dropwise; and the mixture is heated at a temperature of 0 to 200° C. for at least 30 minutes. The above-mentioned solvent is optionally selected from ethyl alcohol, ethyleneglycol, trimethyleneglycol, tetramethyleneglycol, benzene and xylene.

There is no limitation to the molar ratio for the reaction of the titanium alkoxide (a) to the aromatic polycarboxylic acid of the general formula (II) or the anhydride thereof. However, if the proportion of the titanium alkoxide is too high, the resultant polyester polymer may have a degraded color tone and/or too low a softening point. On the contrary, if the proportion of the titanium alkoxide is too low, the reaction rate of the polycondensation may decrease. Accordingly, the reaction molar ratio of the titanium alkoxide (a) to the aromatic polycarboxylic acid of the general formula (II) or the anhydric thereof is preferably in the range of from (2:1) to (2:5).

The reaction product (b) produced by the above-mentioned reaction may be employed without refining or after refining by recrystallization thereof by using acetone, methyl alcohol and/or ethyl acetate.

In the present invention, the phosphorus compound (phosphonate compounds) of the general formula (III) usable for the phosphorus compound component (B) for the mixture (1) for the polycondensation catalyst is preferably selected from esters of phosphonic acid derivatives, for example, dimethyl esters, diethyl esters, dipropyl esters and dibutyl esters of phosphonic acid derivatives, for example, carbomethoxymethanephosphonic acid, carboethoxymethanephosphonic acid, carbopropoxymethanephosphonic acid, carbobutoxymethanephosphonic acid, carbomethoxyphenylmethanephosphonic acid, carboethoxyphenylmethanephosphonic acid, carbopropoxyphenylmethanephosphonic acid, and carbobutoxyphenylmethanephosphonic acid.

When the phosphorus compound component (B) comprising the phosphorus component (phosphonate compound) of the general formula (III) is employed for the polycondensation reaction of the aromatic dicarboxylate ester, the reaction thereof with the titanium compound component (A) can proceed at a relatively slow reaction rate compared with a conventional phosphorus compound which is usually used as a conventional stabilizer and, thus, during the polycondensation procedure, the catalytic activity of the titanium compound component (A) can be maintained high for a long time. Therefore, as a result, the amount ratio of the titanium compound component (A) to the aromatic dicarboxylate ester in the polycondensation system can be made low. Also, even if the polycondensation system containing the phosphorus compound component (B) comprising the phosphorus compound of the general formula (III) is added with a large amount of a stabilizer, the thermal stability of the resultant polyester polymer is not decreased and the color tone of the polyester polymer is not affected.

In the present invention, in the case where the mixture (1) is employed for the polycondensation catalyst, the mixture (1) is employed in an amount satisfying the requirements represented by the following expressions of relation (i) and (ii):
1≦Mₚ/M_{Ti}≦15 (i)
and
10≦Mₚ/M_{Ti}≦100 (ii)
wherein M_{Ti} represents a ratio in % of a value in millimoles of titanium element contained in the titanium compound component (A) to a value in mole of the aromatic dicarboxylate ester, and Mₚ represents a ratio in % of a value in millimoles of phosphorus element contained in the phosphorus compound component (A) to the value in moles of the aromatic dicarboxylate ester.

The ratio Mₚ/M_{Ti} is 1 or more but not more than 15, preferably 2 or more but not more than 10. If the ratio Mₚ/M_{Ti} is less than 1, the resultant polyester polymer may have a yellowish color tone, and if the ratio is more than 15, the resultant polycondensation catalyst may exhibit an insufficient polycondensation-reactivity on the polycondensation reaction, and thus the target polyester polymer may be difficult to produce. The range of the ratio Mₚ/M_{Ti} usable for the present invention is narrower than that of the conventional Ti—P catalyst system. By establishing the ratio Mₚ/M_{Ti} in the above-mentioned range, an excellent catalytic effect, which has not been obtained in the conventional Ti—P catalyst system, can be obtained.

The sum of (M_{Ti}+Mₚ) is 10 or more but not more than 100, preferably 20 or more but not more than 70. If the sum of (M_{Ti}+Mₚ) is less than 10, the resultant polyester polymer exhibits an insufficient fiber-forming property, the production efficiency in the melt-spinning procedure is insufficient, and the resultant fibers exhibit an unsatisfactory performances. Also, if the sum of (M_{Ti}+Mₚ) is more than 100, and when the resultant polyester polymer is melt-spun, the foreign matter is accumulated in a small amount around the spinneret. Generally, the M_{Ti} value is preferably 2 to 15% and more preferably 3 to 10%.

In the case where the reaction products (2) are used as a polycondensation catalyst for the present invention, the titanium compounds (c) and (d) for the titanium compound component (C) can be respectively selected from titanium compounds (a) and (b) usable for the titanium compound component (A) of the mixtures (1) for the polycondensation catalyst.

Also, the phosphorus compounds of the general formula (IV) for the phosphorus compound component (D) of the reaction products (2) for the polycondensation catalyst, include, for example, monoalkyl phosphates, for example, mono-n-butyl phosphate, monohexyl phosphate, monododecyl phosphate, monolauryl phosphate, monooleyl phosphate, etc.; monoaryl phosphates, for example, monophenyl phosphate, monobenzyl phosphate, mono(4-ethylphenyl) phosphate, monobiphenyl phosphate, mononaphthyl phosphate, monoanthoryl phosphate, etc.; dialkyl phosphates, for example, diethyl phosphate, dipropyl phosphate, dibutyl phosphate, dilauryl phosphate, dioleyl phosphate, etc; and diaryl phosphates, for example, diphenyl phosphate, etc. Among these phosphate compounds, the monoalkyl phosphates or monoaryl phosphates of the formula (IV), in which n is one, are preferably employed.

The phosphorus compound component (D) usable for the present invention may consist of a mixture of two or more phosphorus compounds of the general formula (IV). For example, a mixture of a monoalkyl phosphate with a dialkyl phosphate and a mixture of a monophenyl phosphate with a diphenyl phosphate are preferably employed. Particularly, in the mixture, a monoalkyl phosphate is preferably contained in an amount of 50% by mass or more, more preferably 90% by mass or more, based on the total mass of the mixture.

The reaction products of the titanium compound component (C) with the phosphorus compound component (D) can be produced by, for example, mixing the components (C) and (D) with each other and heating the resultant mixture in glycol. Namely, when a glycol solution containing the titanium compound component (C) and the phosphorus compound component (D) is heated, the glycol solution becomes cloudy white and the reaction product of the components (C) and (D) with each other is precipitated as a precipitate. The precipitate is collected and used as a catalyst for the production of the polyester polymer.

In the production of the reaction product (2) for the catalyst, the glycol usable as a reaction medium is preferably the same as that used as a glycol component for the polyester polymer to be produced by using the resultant catalyst. For example, in the case where the target polyester polymer is polyethylene terephthalate polymer, ethylene glycol is used, in the case of polytrimethylene terephthalate polymer, 1,3-propanediol is used, and in the case of polytetramethylene terephthalate polymer, tetramethyleneglycol is used.

The reaction product (2) for the polycondensation catalyst for the present invention can be produced by mixing the titanium compound component (C), the phosphorus compound component (D) and glycol altogether and heating the mixture. In this method, however, when the mixture is heated, a reaction product, insoluble in glycol, is produced by the reaction of the titanium compound component (C) with the phosphorus compound component (D), and precipitates in the reaction system. Therefore, the reaction procedure until the precipitation is preferably carried out uniformly. Accordingly, to produce the reaction product precipitate with a high efficiency, preferably a solution of the titanium compound components in glycol and a solution of the phosphorus compound component (D) are separately prepared, and these solutions are mixed together and heated.

The reaction temperature of the components (C) and (D) is preferably in the range of from 50° C. to 200° C., and the reaction time is preferably one minute to 4 hours. If the reaction temperature is too low, the reaction may be incompletely effected or a very long reaction time may be needed, and thus the target reaction product precipitate may not be obtained by a uniform reaction with a high efficiency.

In the reaction in glycol under heating, the phosphorus compound component (D) and the titanium compound component (C) are preferably subjected, in a ratio, in terms of molar ratio of phosphorus atoms to titanium atoms, of 1.0 to 3.0, more preferably 1.5 to 2.5. When the components (D) and (C) are employed in the above-mentioned ratio, the phosphorus compound component (D) can be substantially completely reacted with the titanium compound component (C), and substantially no incompletely reacted product is present in the reaction product. Therefore, the resultant reaction product can be used for the catalyst without refining, and the resultant polyester polymer has a good color tone. Also, as the reaction product contains substantially no unreacted phosphorus compound of the formula (IV), the polycondensation reaction for the production of the polyester can be conducted with a high productivity and without obstruction due to the non-reacted phosphorus compound.

The reaction product (2) for the polycondensation catalyst usable for the present invention preferably contains the compound represented by the general formula (V):

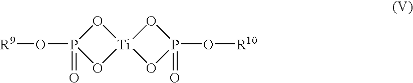

In the formula (V), R⁹ and R¹⁰ respectively and independently from each other represent a member selected from alkyl groups having 1 to 10 carbon atoms and derived from the R¹, R², R³ and R⁴ groups in the general formula (I) which represents the titanium alkoxide for the titanium compound component (C) and R⁸ in the general formula (IV) which represents the phosphorus compound for the phosphorus compound component (D), or aryl groups having 6 to 12 carbon atoms and derived from the R⁸ group of the phosphorus compound of the formula (IV).

The reaction product of the formula (V) for the titanium compound with the phosphorous compound of the formula (IV), has a high catalytic activity and the polyester polymer produced by using this reaction product exhibits a good color tone (a low b* value), and contains acetaldehyde, residual metals and cyclic trimers in sufficiently low amounts in practice and has practically satisfactory polymer properties. The reaction product represented by the formula (V) is preferably contained in a content of 50% by mass or more, more preferably 70% by mass or more, in the polycondensation catalyst.

In the polycondensation of the aromatic dicarboxylate ester in the presence of the above-mentioned reaction product (2), the precipitate of the reaction product (2) suspended in glycol can be employed as a catalyst without separating the precipitate from glycol. Alternately, the reaction product precipitate is separated from the suspension thereof in glycol by a centrifugal precipitation treatment or a filtration treatment, the separated reaction product is refined by a recrystallization treatment in a recrystallizing agent, for example, acetone, methyl alcohol and/or water, then the refined product is employed as a poly-condensation catalyst. The chemical structure of the reaction product (2) for the polycondensation catalyst can be confirmed by a metal quantitative determination according to solid NMR and XMA.

The polyester polymer usable for the present invention is produced by a polycondensation of an aromatic dicarboxylate ester in the presence of a catalyst comprising a mixture (1) of the titanium compound component (A) with the phosphorus compound (phosphonate compound) component (B) and/or a reaction product (2) of the titanium compound component (C) with the phosphorus compound component (D). In the present invention, the aromatic dicarboxylate ester is preferably a diester of an aromatic dicarboxylic acid component with an aliphatic glycol component.

The aromatic dicarboxylic acid component usable for the present invention preferably comprises, as a principal component, terephthalic acid. More particularly, the terephthalic acid is contained in a content of 70 molar % or more on the basis of the total content of the aromatic dicarboxylic acid component. The preferable aromatic discarboxylic acids other than terephthalic acid for the present invention include, for example, phthalic acid, isophthalic acid, naphthalene dicarboxylic acid, diphenyldicarboxylic acid and diphenoxyethane dicarboxylic acid.

The aliphatic glycol component usable for the present invention preferably comprises an alkylene glycol, for example, ethylene glycol, trimethylene glycol, propylene glycol, tetramethylene glycol, neopentyl glycol, hexamethylene glycol, dodecamethylene glycol, etc. Among them, ethylene glycol is more preferably employed.

In the present invention, the polyester polymer is preferably selected from polyester polymers having, as principal repeating units, ethylene terephthalate groups formed from terephthalic acid and ethylene glycol. In this case, the repeating ethylene terephthalate units are preferably contained in a content of 70 molar % or more based on the total molar amount of the repeating units.

The polyester polymer usable for the present invention may be selected from copolyester polymers containing comonomer components, as acid components or diol components, capable of forming the polyester structure.

The carboxylic acid components for the copolyester include difunctional carboxylic acids, such as the above-mentioned aromatic dicarboxylic acids, aliphatic dicarboxylic acids, for example, adipic acid, sebasic acid, azelaic acid and decanedicarboxylic acid, and cycloaliphatic dicarboxylic acids, for example, cyclohexanedicarboxylic acid, and ester-forming derivatives of the difunctional carboxylic acids. Also, the diol components for the copolyester include the above-mentioned aliphatic diols, cycloaliphatic glycol compounds, for example, cyclohexane diol, and aromatic diol compounds, for example, bisphenol, hydroquinone, and 2,2-bis(4-β-hydroxyethoxyphenyl) propane.

Further, copolyester polymers produced by copolymerizing a copolymerization component comprising polyfunctional compounds, for example, trimesic acid, trimethylolethane, trimethylolpropane, trimethylolmethane and pentaerythriol, can be used for the present invention.

In the present invention, the homopolyester polymers and the copolyester polymers may be employed alone or in a mixture of two or more thereof.

For the polyester polymer for the polyester multifilament-yarn of the present invention, polycondensation products of aromatic dicarboxylate ester produced from the above-mentioned aromatic dicarboxylic acid and aliphatic glycol are preferably used. The aromatic dicarboxylate ester can be produced by a diesterification reaction of the aromatic dicarboxylic acid with the aliphatic glycol, or by a transesterification reaction of a dialkylester of the aromatic dicarboxylic acid with an aliphatic glycol. The production of the polyester polymer through the transesterification reaction using, as a starting compound, the dialkyl ester of the aromatic dicarboxylate, is advantageous in that the polycondensation procedure can be carried out with less scattering, of the phosphorus compound added as a phosphorus stabilizing agent to the polycondensation system, in comparison with the polycondensation procedure of the aromatic dicarboxylate ester produced by the diesterification reaction of the aromatic dicarboxylic acid.

Further, preferably a portion or all of the titanium compound component (A) or (C) is mixed with the reaction system before the start of the transesterification reaction, to utilize the titanium compound component (A) or (C) as a catalyst for both the transesterification and polycondensation reactions. In this utilization of the titanium compound component (A) or (C), the final content of the titanium compound component in the polyester polymer can be reduced. Particularly, in the production of, for example, polyethylene terephthalate, the transesterification reaction of a dialkyl ester, of an aromatic dicarboxylic acid component including, as a principal component, terephthalic acid, with ethylene glycol is preferably carried out in the presence of the titanium compound component (A) comprising at least one member selected from the group consisting of titanium alkoxides (a) represented by the general formula (I), and reaction products (b) produced by a reaction of the titanium alkoxides represented by the general formula (I) with an aromatic polycarboxylic acids represented by the general formula (II) or anhydrides thereof. Then, the reaction mixture produced by the transesterification reaction and containing the diester of the aromatic dicarboxylic acid with ethylene glycol is added with a phosphorous compound (phosphate component) component (B) represented by the general formula (III), or with a reaction product of the titanium compound component (C) with the phosphorous compound component (D), to proceed the polycondensation reaction of the aromatic dicarboyxlate ester.

Usually the transesterification reaction is carried out under the ambient atmospheric pressure. When the reaction is carried out under a pressure of 0.05 to 0.20 MPa, a transesterification reaction due to the catalystic activity of the titanium compound component (A) is further promoted, and the generation of a by-product consisting of diethylene glycol, does not occur in a large amount. These effects enable the resultant polyester polymer to exhibit a further improved performance such as, for example, thermal stability. The transeterification reaction is preferably carried out at a temperature of 160 to 260° C.

In the present invention, where terephthalic acid is used as an aromatic dicarboxylic acid, the terephthalic acid and dimethyl terephthalate are employed as starting materials for the polyester. In this case, a recycled dimethyl terephthalate obtained by depolymerizing a polyalkylene terephthalate or a recycled terephthalic acid obtained by hydrolyzing the recycled dimethyl terephthalate may be used. It is particularly preferred to use, as the material source for preparation of a polyester, recovered PET bottles, recovered polyester, fiber products and recovered polyester film products, in view of the effective utilization of resources.

The polycondensation reaction may be carried out in a single reactor or successively conducted in a plurality of reactors. The polyester polymer produced by the above-mentioned polycondensation procedure is usually extruded in a melt state into a filamentary form, and the filamentary melt stream of the polyester polymer is cooled and then shaped (cut) into a chip form.

The resultant polyester polymer preferably has an intrinsic viscosity of 0.40 to 0.80, more preferably 0.50 to 0.70.

The procedures for producing the polyester polymer including the esterification step and the polycondensation step may be carried out by using a batch type, semi-continuous or continuous reactor.

The polyester polymer obtained by the polycondensation procedure is optionally further subjected to a solid phase polycondensation procedure.

The solid phase polycondensation procedure is carried out in one or more stages, at a temperature of 200 to 235° C., under a pressure of 1 kPa to 200 kPa, for 5 to 15 hours in an inert or unreactive gas atmosphere comprising, for example, nitrogen, argon and/or carbon dioxide gas.

The polyester polymer produced by the above-mentioned procedures and usable for the present invention preferably has an intrinsic viscosity in the range of from 0.64 to 1.00, more preferably from 0.70 to 0.95, still more preferably 0.75 to 0.95.

In the case where the intrinsic viscosity is too low, the resultant filaments may exhibit an insufficient mechanical strength and even when the draw ratio is increased to increase the mechanical strength, the resultant filaments may exhibit a low ultimate elongation and thus the resultant multifilament yarn may be difficult to exhibit a target silk factor value. Also, when the intrinsic viscosity is too high, and particularly, when the target thickness of the individual filaments is low, the filament-forming procedure may become difficult. The intrinsic viscosity of the polyester polymer is preferably controlled by controlling the conditions for the solid phase polymerization reaction.

The polyester polymer produced through the above-mentioned solid phase polycondensation procedure and in the form of chips is optionally further treated with water by contacting water, water vapor, water vapor-containing inert gas or water vapor-containing air with the polymer, to deactivate the catalyst contained in the polymer chips.

The polyester polymer usable for the present invention optionally further comprises a small amount of additives. Particularly, titanium dioxide is used as a dulling agent and an antioxidant is used as a stabilizing agent for the polymer.

The polyester polymer usable for the present invention is preferably selected from polyethylene terephthalate, polytrimethylene terephthalate, and polytetramethylene terephthalate. Particularly, polyethylene terephthalate is more preferably used.

The polyester polymer usable for the present invention preferably has an L* value of 68 to 90, more preferably 73 to 90 and a b* value of 1 to 10 more preferably 1 to 9, still more preferably 1 to 5, determined in accordance with the L*a*b* color specification of JIS Z 8729.

The polyester polymer usable for the present invention optionally contains a small amount of an additive, for example, an antioxidant, an ultraviolet ray-absorber, a flame detardent, a fluorescent brightening agent, a dulling agent, a color tone-controlling agent, a defoaming agent, an antistatic agent, an antibacterial agent, a light stabilizer, a thermal stabilizer and a light-screening agent. Particularly, the polyester polymer is preferably added with titanium dioxide as a dulling agent and an antioxidant as a stabilizer.

The titanium dioxide is preferably in the form of particles having an average particle size of 0.01 to 2 μm and is preferably contained in a content of 0.01 to 10% by mass in the polyester polymer.

The content of titanium derived from the above-mentioned catalyst and contained in the resultant polymer is distinguished from that derived from titanium dioxide added as a dulling agent to the polymer.

In the case where the polyester polymer contains titanium dioxide as a dulling agent in the polyester polymer, and only the dulling agent consisting of titanium dioxide is removed from a sample of the polyester polymer to be subjected to a measurement, the sample of the polyester polymer is dissolved in hexafluoroisopropanol, the solution is subjected to a centrifugal separation testament to separate and precipitate the particles of titanium dioxide from the solution, an upper clear liquid fraction of the solution is collected by a tilting method, and the solvent is evaporated away from the collected liquid fraction, to provide a polymer sample to be subjected to the measurement.

The antioxidant preferably comprises a hindered phenolic antioxidant. The antioxidant is contained in a content of 1% by mass or less, more preferably 0.005 to 0.5% by mass in the polyester polymer. If the content of the antioxidant is more than 1% by mass, the anti-oxidation effect of the resultant resin may be saturated and too high a content of the antioxidant may cause scum to be generated in the polyester polymer melt during the melt spinning procedure. Also, the hindered phenolic antioxidant may be employed, in combination with a thioether antioxidant, against secondary oxidation.

There is no limitation to the manner of mixing the antioxidant into the polyester polymer. The mixing procedure may be carried out in any stage between the start of the transesterification reaction and the end of the polycondensation reaction.

The polyester multifilament yarn of the present invention is a yarn consisting of multifilaments formed form the above-mentioned polyester polymer. The use of the polyester polymer enables the resultant multifilament yarn to exhibit a reduced defect due to fluffs, a high mechanical strength even when the individual filament thickness is low, and a good color tone.

The polyester multifilament yarn of the present invention has an individual filament thickness of 0.3 to 2.0 dtex. More preferably, the individual filament thickness is 0.5 to 1.6 dtex. By using the filaments having a low individual filament thickness, the hand of the resultant multifilament yarn can be improved. Also, the total thickness of the multifilament yarn of the present invention produced by bundling the filaments having a low individual filament thickness must be 90 dtex or less, preferably 80 dtex or less. Also, the total thickness of the polyester multifilament yarn of the present invention preferably 15 dtex or more, more preferably 20 dtex or more. The use of the multifilament yarn having the total thickness in the above-mentioned range enables the resultant fabrics to have a soft hand. Also, the multifilament yarn as mentioned above can be converted to high density woven or knitted fabrics having a small area of intersecting portions of the yarns from which a woven or knitted fabric is formed. The high density woven or knitted fabrics have excellent windbreaking performance. The multifilament yarn of the present invention preferably consists of 10 to 500 filaments, more preferably 20 filaments or more but not more than 288 filaments.

The silk factor (which is referred to as S.F.) of the multifilament yarn is a yarn property as defined by the equation:
S.F.=(Tensile strength of yarn)×(Ultimate elongation of yarn)^{1/2}

In the polyester multifilament yarn of the present invention, the S.F. is 22 or more, preferably 22 to 35. If the S.F. is less than 22, the resultant woven or knitted fabric produced from the polyester multifilament yarn exhibits an insufficient mechanical strength in practice.

The polyester multifilament yarn of the present invention having an S.F. of 22 or more exhibits a high performance in the fields of sport wear and industrial material fabrics.

To provide the polyester multifilament yarn of the present invention with an S.F. of 22 or more, the tensile strength of the multifilament yarn is preferably 4.5 cN/dtex or more, more preferably 4.7 cN/dtex or more but not more than 7 cN/dtex. The multifilament yarn of the present invention having a high mechanical strength enables the resultant woven or knitted fabric from the yarn to exhibit high tensile strength and tear strength.

The ultimate elongation of the multifilament yarn is an important performance of the yarn and greatly influences on the tear strength of the resultant fabric from the yarn. A high ultimate elongation of the yarn enables the resultant woven or knitted fabric to absorb and diversify an external force applied to the fabric, to enhance the tear strength of the fabric. In view of this, if the S.F. value is less than 22, the resultant woven or knitted fabric cannot fully absorb and diversify the external force applied to tear the fabric, and thus exhibits an insufficient utilizability in practice.

The woven or knitted fabric produced from the polyester multifilament yarn of the present invention preferably has a tear strength of 9 to 30N, more preferably 9.8 to 20N.

In the present invention, there is no limitation to the process for producing the fibers from the polyester polymer, and the conventional polyester melt-spinning process can be used for the polyester fiber. For example, the above-mentioned polyester polymer is melted at a temperature in the range of from 270 to 300° C., and the melt is melt spun by extruding the melt through spinning orifices for multifilaments. In this melt-spinning procedure, the melt-spinning speed is preferably 400 to 5000 m/min. When the melt-spinning procedure is carried out at a speed in the above-mentioned range, the resultant filaments may exhibit a sufficient mechanical strength and may be wound-up in a stable condition. The resultant undrawn polyester filaments are wound-up and then subjected to a drawing procedure or are continuously subjected to the drawing procedure without winding-up. The polyester filament yarn of the present invention may be subjected to a mass-reduction treatment with an alkali, to improve the hand of the filament yarn.

In the production of the polyester multifilaments, there is no limitation to the form of the spinning orifices. The spinning orifices may have a circular or irregular cross-sectional profiles, for example, a triangular, another polygonal, or a flat cross-sectional profile and may be for hollow or non-hollow filaments. The melt-spun, undrawn multifilament yarn may be wound-up and then unwound and subjected to a drawing procedure or may be directly subjected to the drawing procedure without winding up.

The polyester multifilament yarn usable for the present invention may be in the form of twisted yarns or non-twisted yarns. Further, the polyester multifilament yarn usable for the present invention may be in the form of false-twist textured fiber yarns, traslan-textured filament yarns or yarns interlaced by an interlacing method using air jet streams. The polyester multifilament textured yarn produced by the above-mentioned texturing procedures, enables the resultant woven or knitted fabric from the yarn to exhibit an increased puffy, bulky, warm and soft hand.

Further, to improve the hand of the polyester multifilament yarn of the present invention, a mass-reduction treatment with an alkali is preferably applied to the yarn.

The polyester multifilament yarn of the present invention produced in the manner as mentioned above can be woven or knitted with a low fluff defect, and exhibits excellent reeling property and weaving and knitting properties. The resultant woven and knitted fabrics exhibit good color tone, and thus are preferably utilized in sport wears and fabrics for industrial materials, for example, various types of uniforms, training wear, sport shirts, raincoats, umbrellas, paragliders and yacht sails.

### EXAMPLES

The present invention will be further illustrated by the following examples which are not intended to restrict the scope of the present invention in any way.

In each of Examples 1 to 3 and Comparative Examples 1 and 2, properties of polyester polymers and polyester multifilament yarns were measured by the following measurements.

(1) Intrinsic Viscosity

An intrinsic viscosity (IV) of a polyester polymer was determined from values of the viscosity of a solution of 0.6 g of the polyester polymer dissolved in 50 ml of orthochlorophenol at 35° C. and measured at 35° C., using an Ostwald viscometer.

(2) Color Tone (L* Value and b* Value)

A polyester polymer sample was melted at 290° C. under vacuum for 10 minutes and was formed, on an aluminum plate, into a plate form having a thickness of 3.0±1.0 mm. The resultant plate-shaped polyester test piece was immediately quenched in iced water, and then subjected to a drying and crystallization treatment at 160° C. for one hour. The resultant plate-shaped polyester test piece was placed on a white standard plate for regulating a color-difference meter and Hunter's L* value and b* value of the surface of the plate-shaped polyester teat piece in accordance with the L*a*b* color specification (JIS Z 8729) was measured by a Hunter's color-difference meter CR-200 manufactured by Minolta Co., Ltd. The L* value means the lightness and the lightness of the test piece increases as the numerical value increases, while the b value represents a yellowness and the yellowness of the test piece increases as the b value increases.

(3) Metal Concentration Analysis

In the measurement of concentrations of metals in the polyester polymer, a sample of the polymer catalystic in the form of grains was heat-melted on an aluminum plate, the polymer melt was formed into a shaped specimen having a flat surface by using as compression press and the shaped specimen was subjected to an quantitative analysis using a fluorescent X-ray analysis apparatus (model: 3270E, made by RIGAKUDENKIKOGYO K.K.).

In the measurement of titanium concentration of a polyester polymer containing titanium dioxide as a dulling agent, a sample of the polyester polymer was dissolved in hexafluoro-isopropanol, the solution was subjected to a centrifugal treatment to cause titanium dioxide particles to deposit, a clear upper liquid fraction of the solution was collected by a decantation method and the solvent was evaporated away from the collected liquid fraction, to provide a sample for measurement. The sample was subjected to the analysis.

In the measurement of concentrations of titanium and phosphorus atoms in the reaction product catalyst, a dried catalyst sample was mounted in a scanning electron microscope (Model S570, manufactured by Hitachi Instruments Service Co., Ltd.) and the concentration of titanium and phosphorus atoms in the catalyst was determined by using an energy dispersive X-ray microanalyzer (XMA, Model EMAX-7000, manufactured by Horiba Seisakusho, K.K.) connected to the scanning electron microscope.

(4) Content of Diethylene Glycol (DEG)

A sample of the polyester polymer was decomposed with hydrated hydrazine, and the resultant decomposition product was subjected to a gaschromatographic analysis using a gaschromatograph (model: 263-70, made by K.K. HITACHI SEISAKUSHO) to determine the content (mass %) of diethyleneglycol.

(5) Height of Foreign Matter Layer Deposited on Melt-Spinning Spinneret

After a polyester sample was formed into chips, the resultant chips were melted at 290° C. and the melt was melt-spun by extruding through a spinning spinneret with 12 holes having a hole diameter of 0.15 mm at a extrusion rate of 600 m/min., for 2 days. The height of the layer of a foreign matter deposit formed on an outer periphery of the extrusion hole of the spinneret was measured. The larger the height of the layer of the deposit, the more easily a bending phenomenon of a filament-shaped stream of the extruded polyester melt occurs, resulting in decreased formability of the polyester. That is, the height of the layer of the deposit formed on the spinning spinneret is an index of the formability of the polyester.

(6) Breakages of Filament Yarn

In continuous melt-spinning procedures, and over three days, the number of breakages of the filament yarn was counted.

(7) Formation of Fluffs (Fluffs/10⁶ m)

A multifilament yarn composed of 250 dividual filaments and wound up in the form a package or on a pirn was subjected to a warping procedure using a warping machine equipped with a fluff detecter at a warping speed of 400 m/min for 42 hours. At every step of the warping machine, presence of fluff was checked by the naked eye, and the total number of the fluffs found on the filament yarn per a length of 10⁶ m was calculated.

(8) Tensile Strength, Ultimate Elongation and Silk Factor (S.F.) of Multifilament Yarn.

In accordance with JIS L 1013, the tensile strength and the ultimate elongation of the multifilament yarn were determined and the S.F. of the yarn was calculated from the data of the tensile strength and the ultimate elongation.

(9) Tear Strength

In accordance with JIS L 1096, 6.15.5, D (pendulum method), the tear strength of a sample of a polyester multifilament woven fabric was determined.

### Example 1

A mixture of 100 parts by mass of dimethyl terephthalate with 70 parts by mass of ethylene glycol was further mixed with 0.009 part by weight of tetra-n-butyl titanate. The resultant mixture was placed in a stainless steel reactor having heating means and pressurizing means, the pressure of the inside of the reactor was increased to 0.07 MPa and the temperature of the mixture was increased into the range of from 140° C. to 240° C., to subject the mixture to a transesterification reaction. Then, the reaction mixture was further mixed with 0.35 part by mass of triethyl phosphonoacetate (TEPA), and 0.07 part by mass of a dulling agent consisting of TiO₂, and then the transesterif ication reaction was ended. The reaction mixture was moved to a polymerization reactor, heated to a temperature of 290° C., and subjected to a polycondensation reaction under a high vacuum of 26.67 Pa or less. A polyester polymer having an intrinsic viscosity of 0.63 and a diethyleneglycol content of 0.6% by mass was obtained.

The resultant polyester polymer was formed into chips.

The polyester polymer chips were placed in a solid phase polymerization apparatus, and subjected to the polymerization reaction at 220° C. for 10 hours. The resultant polyester polymer chips had an intrinsic viscosity of 0.9.

The polyester polymer chips were dried and then placed in a melt-spinning apparatus in which the polyester polymer chips were melted and extruded through a melt-spinneret having 36 spinning orifices at an extrusion rate of 15.4 g/min. In this procedure, the temperature of a hot zone located 90 mm below the spinneret was controlled to 400° C. by a heater. Toward the extruded filamentary streams of the polyester polymer melt, a cooling blast was blown at temperature of 25° C. at a humidity of 65% at a blowing speed of 30 cm/sec., to cool and solidify the melt streams. Then the solidified multifilaments were oiled with an oiling agent by an oiling roller. The oiled multifilaments were subjected to a filament-interlacing procedure to impart interlaces between the filaments at a number of interlacing of 3 interlaces/m. The resultant undrawn multifilament bundle was taken-up at a taking-up speed of 1000 m/min. and then successively pre-heated at a pre-heating temperature of 90° C. without interrupting, and then drawn at a heat-setting temperature of 120° C. at a draw ratio of 3.2. The resultant drawn multifilament yarn was wound up at a taking-up speed of 3200 m/min while, immediately before the taking up, the drawn multifilament yarn was subjected to an interlacing procedure at a number of interlacings of 10 interlaces/m. The resultant drawn multifilament yarn has a yarn count of 44 dtex/36 filaments.

The above-mentioned spinning procedure was continuously carried out for 3 days. In the result, no breakage of the yarn occurred. Namely, the above-mentioned polyester polymer exhibited a good filament-forming property and the lapse of spinning time did not cause the filament-forming efficiency of the polyester polymer to decrease. Also, the height of the foreign matter deposit around the spinneret was 5 μm, which was very low. The resultant drawn multifilament yarn exhibited a tensile strength of 4.9 cN/dtex and a silk factor of 23. The number of fluffs generated on the yarn was 0.04 fluffs/10⁶ m and thus the yarn exhibited a high fluff-preventing property. The resultant yarn had a very good color tone free from yellowish tone.

The polyester multifilament yarn was converted to a plain weave having a warp density of 249 warps/3.79 cm and a weft density of 194 wefts/3.79 cm. The resultant plain weave was subjected to a measurement of tear strength. The determined tear strength was 11.4N and satisfactory. The resultant woven fabric had a high softness and exhibited good hand.

The test results are shown in Table 1.

### Example 2

A polyester polymer, a polyester multifilament yarn and a plain weave were produced by the same procedures as in Example 1, with the following exception.

As a titanium component for the catalyst, 0.016 part by mass of titanium trimellitate produced by the method shown below was employed.

Synthesis of Titanium Trimellitate

A solution of 0.2% of trimellitic anhydride in ethylene glycol was mixed with titanium tetrabutoxide in an amount of ½ mole per mole of the trimellitic anhydride, and the resultant mixture was subjected to a reaction by keeping the mixture in the air atmosphere under the ambient atmospheric pressure at a temperature of 80° C. for 60 minutes. The reacted mixture was cooled to room temperature. The resultant catalyst was crystallized by using acetone in an amount of 10 times the amount of the mixture, the resultant deposit was separated by a filtration using a filter paper, and the filtered deposit was dried at 100° C. for 2 hours, to provide a target titanium compound.

The resultant plain weave was soft and exhibited a good hand.

The test results are shown in Table 1.

### Example 3

A polyester polymer, a polyester multifilament yarn and a plain weave were produced by the same procedures as in Example 1, except that the polyester polymer chips were produced by the following procedures.

Production of Polyester Polymer

In a reactor in which 225 parts by mass of a polyester oligomer were contained and were conditioned at a temperature of 255° C. under the ambient atmospheric pressure in a nitrogen gas atmosphere, a slurry prepared by mixing 179 parts by mass of a high purity terephthalic acid with 95 parts by mass of ethylene glycol was fed at a constant feed rate, to carry out an esterification reaction of terephthalic acid with ethylene glycol. The esterification reaction was carried out for 4 hours while water and ethylene glycol generated due to the reaction were distilled out of the reaction system, to complete the reaction. In this reaction, the degree of esterification was 98% or more, and the degree of polymerization of the resultant oligomer was about 5 to 7.

The oligomer is an amount of 225 parts by mass produced by the esterification reaction was placed in a polycondensation vessel, and mixed with 3.34 parts by mass of a TP catalyst which will be explained hereinafter. The resultant polycondensation system was heated stepwise to a temperature of from 255° C. to 280° C. and the pressure of the reaction system was reduced stepwise from the ambient atmospheric pressure to 60 Pa, while removing water and ethylene glycol generated due to the reaction from the vessel to the outside of the vessel, to effect the polycondensation reaction.

The degree of proceeding of the polycondensation reaction was checked by monitoring the load on the stirring paddles in the reaction system, and when the degree of polymerization of the polyester polymer reached the desired level, the reaction was ended. Then, the reaction product in the polycondensation system was continuously extruded through an extrusion hole formed in the polycondensation reactor into the form of a strand. The extruded polymer strand was cooled and cut into a pellet form, to provide polyethylene terephthalate chips having a diameter of about 3 mm.

Production of TP catalyst

(1) Preparation of Titanium Compound

Ethylene glycol in an amount of 919 g and acetic acid in an amount of 10 g were placed in a three necked flask having a capacity of 2 liters and capable of mix-stirring the contents of the flask, and mix-stirred.

The resultant mixture was gradually mixed with 71 g of titanium butoxide to provide a clear solution of the titanium compound in ethylene glycol. This solution will be referred to as a TB solution, hereinafter. In this TB solution, the titanium atom concentration was 1.02%.

(2) Preparation of Phosphorus Compound

Ethylene glycol in an amount of 656 g was placed in a three necked flask having a capacity of 2 liters and capable of heating and mix-stirring the content in the flask and heated to a temperature of 100° C. while it is stirred. When it reached the target temperature, 34.5 g of monolauryl phosphate were mixed and dissolved in ethylene glycol while heating and stirring, to provide a clear solution. This solution will be referred to as a P solution, hereinafter.

(3) Preparation of a Catalyst

The above-mentioned P solution (about 690 g) was heated and controlled to a temperature of 100° C., and the above-mentioned TB solution in an amount of 310 g was gradually mixed with the P solution while stirring. After all of the TB solution is mixed into the P solution, the mixture was kept at a temperature of 100° C. for one hour while stirring, to complete the reaction of the titanium compound with the phosphorous compound. The mixing ratio of the P solution to the TB solution was controlled so that the molar ratio of phosphorus atoms in the P solution to titanium atoms in the TB solution was 2.0. The product produced by the above-mentioned reaction was insoluble in ethylene glycol, and thus is present in the form of fine deposits which caused the resultant reaction liquid to be white and cloudy. The resultant liquid will be referred to as a TP catalyst, hereinafter.

(4) Analysis of the Reaction Deposits

To analyze the composition of the reaction deposits, a portion of the reaction liquid was filtered through a filter, to collect the reaction deposits as a solid fraction. The collected solid fraction was washed with water and dried. The dried reaction deposits were subjected to an elemental analysis using a XMA analyzing method. As a result, the elemental concentration of titanium was 12.0%, the concentration of phosphorous was 16.4% and the molar ratio of phosphorus atoms to titanium atoms was 2.1. Further, the reaction deposits was subjected to a solid NMR analysis. The results were as follows.

Disappearance of the peaks of the chemical shifts at 14 ppm, 20 ppm and 36 ppm derived from the butoxide groups of titanium tetrabutoxide was observed by the C-13 CP/NAS (frequency of 75.5 Hz) measurement method. Also, in a P-31 DD/MAS (frequency of 121.5 Hz) measurement method, a new chemical shift peak at 22 ppm which had not existed in monolauryl phosphate was confirmed. From the above-mentioned measurement results, it was definitely confirmed that the deposits obtained under the above-mentioned conditions contained a compound produced by the reaction of the titanium compound with the phosphorus compound.

(5) Sold Phrase Polymerization

The polyester polymer chips were placed in a solid phase polymerization apparatus and subjected to a solid phase polymerization treatment at 220° C. for 10 hours. The resultant polyester polymer chips had an intrinsic viscosity of 0.88.

(6) Production of Multifilament Yarn

The melt-spinning procedure were continuously carried out for 3 days.

In the results of the melt-spinning procedure, no breakage of yarn occurred, the melt-spinning property of the polymer was good and no degradation in the spinning property due to the lapse of spinning occurred. In this procedure, the height of the foreign matter deposits around the spinneret was 7 μm which was very low. The resultant filament yarn exhibited a tensile strength of 4.8 cN/dtex and a silk factor of 22. J. Also, the number of fluffs generated on the yarn was 0.07 fluffs/10⁶ m which value was good. The yarn had a very good color tone and was free from yellowish color.

(7) Weaving

A plain weave having a warp density of 249 yarns/3.79 cm and a weft density of 194 yarns/3.79 cm was produced from the above-mentioned polyester multifilament yarns. The weave exhibited a tear strength of 11.2N which was in a fully satisfactory level.

The resultant fabric was soft and exhibited a satisfactory hand.

### Comparative Example 1

A polyester polymer having an intrinsic viscosity of 0.63 was produced by the same procedures as in Example 1, except that the solid phase polymerization treatment was omitted. From the polyester polymer, a drawn filament yarn having a yarn count of 44 dtex/12 filaments was produced by the same procedures as in Example 1 and then from the yarn, a fabric was produced by the same procedures as in Example 1, with the following exceptions.

The number of the spinning orifices in the spinneret was changed to 12, and the draw ratio was changed to 3.7.

The resultant fabric had a stiffish hand and thus was unsatisfactory.

The test results are shown in Table 1.

### Comparative Example 2

A mixture of 100 parts by mass of dimethyl terephthalate with 70 parts by mass of ethylene glycol and 0.064 part by mass of calcium acetate monohydrate were charged in a stainless steel container in which a reaction can be effected under pressure, the charged mixture was heated from a temperature of 140° C. to a temperature of 240° C. under a pressure of 0.07 MPa, to cause a transesterification reaction to occur; the reaction mixture liquid was added with 0.044 part by mass of an aqueous solution of phosphoric acid in a concentration of 56% by mass, and 0.07% by mass of a dulling agent consisting of TiO₂, to complete the transesterification reaction.

Then, the reaction product was moved to a polymerization container and mixed with diantimony trioxide in the amount shown in Table 1, the mixture was heated to a temperature of 290° C. and subjected to a polycondensation reaction under a high vacuum of 26.67 Pa or less, to produce a polyester polymer having an intrinsic viscosity of 0.631 and a content of diethylene glycol of 0.55%. The resultant polyester polymer was molded to chips. The polyester polymer chips were, then, placed in a solid phase polymerization apparatus and subjected to a solid phase polymerization reaction at 220° C. for 8 hours. Polyester polymer chips having an intrinsic viscosity of 0.92 were obtained. From the polyester polymer chips, a polyester multifilament yarn, and a fabric, were produced by the same procedures as in Example 1. In the melt-spinning procedure, it was observed that occurrences of breakage of the yarn and the generation of fluffs on the yarn increased with the lapse of the melt-spinning time.

The test results are shown in Table 1.

TABLE 1

| | | Item | | | | | | | | | |
|---|---|---|---|---|---|---|---|---|---|---|---|
| | | Catalytic component | | | | | | | | | |
| | | | | | | Sb | | | Polyester Polymer | | |
| | | Ti compound | | P compound | | compound | | | | Color | |
| Example | | | Content | | Content | Content | | Mₚ/M_{Ti} | Intrinsic | tone | |
| No. | | Type | (mmol %) | Type | (mmol %) | (mmol %) | Mₚ/M_{Ti} | (mmol %) | viscosity | L* | b* |
| Example | 1 | TBT | 5 | TEPA | 30 | — | 6 | 35 | 0.900 | 79.0 | 3.0 |
| | 2 | TMT | 5 | TEPA | 30 | — | 6 | 35 | 0.900 | 80.0 | 2.9 |
| Comparative | 1 | TBT | 5 | TEPA | 30 | — | 6 | 35 | 0.630 | 80.0 | 2.6 |
| Example | 2 | — | — | — | — | 31 | — | — | 0.920 | 70.0 | 2.8 |

Item

| | | Melt-spinning property | | | Filament property | | Fabric |
|---|---|---|---|---|---|---|---|
| | | yarn | Height of | | Tensile | | property |
| Example | | breakage | foreign matter | Fluffs | strength | | Tear |
| No. | | per 3 days | deposit (μm) | per 10⁶ m | (cN/dtex) | S.F. | strength (N) |
| Example | 1 | 0 | 5 | 0.04 | 4.9 | 23 | 11.4 |
| | 2 | 1 | 6 | 0.04 | 4.8 | 23 | 11.3 |
| Comparative | 1 | 0 | 7 | 0.03 | 4.3 | 21 | 6.7 |
| Example | 2 | 10 | 33 | 0.15 | 4.7 | 23 | 11.1 |

Note:
TBT: Titanium tetra-n-butoxide
TMT: Titanium trimellitate
TEPA: Triethyl phosphonoacetate

1. A polyester multifilament yarn comprising, as a principal component, a polyester polymer produced by polycondensing an aromatic dicarboxylate ester in the presence of a catalyst,
wherein
the catalyst comprises at least one member selected from mixtures (1) and reaction products (2);
the mixtures (1) for the catalyst comprises a titanium compound component (A) mixed with phosphorus compound component (B),
in which mixtures (1),
the component (A) comprises at least one member selected from the group consisting of (a) titanium alkoxides represented by the general formula (I): 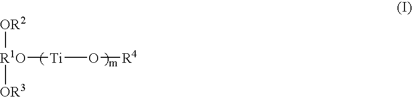
in which formula (I), R¹, R², R³ and R⁴ respectively and independently from each other represent a member selected from alkyl groups having 1 to 20 carbon atoms and a phenyl group, m represent an integer of 1 to 4, and when m represents an integer of 2, 3 or 4, the 2, 3 or 4 R²s and R³s may be respectively the same as each other or different from each other, and (b) reaction products of the titanium compounds of the general formula (I) with aromatic polycarboxylic acids represented by the formula (II): 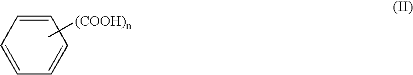
(II)
in which formula (II), n represents an integer of 2 to 4, or anhydrides of the acids of the formula (II); and
the component (B) comprises at least one phosphorus compound represented by the general formula (III): 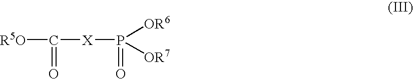
in which formula (III), R⁵, R⁶ and R⁷ respectively and independently from each other represent an alkyl group having 1 to 4 carbon atoms, X represents a member selected from a —CH₂— group and a —CH(Y)— group (wherein Y represents a phenyl group),
the mixture (1) for the catalyst for the polycondensation being employed in an amount satisfying the requirements represented by the following expressions of relation (i) and (ii):
1≦Mₚ/M_{Ti}≦15 (i)
and
10≦Mₚ+M_{Ti}≦100 (ii)
wherein M_{Ti} represents a ratio in % of a value in millimoles of titanium element contained in the titanium compound component (A) to a value in moles of the aromatic dicarboxylate ester, and M_{P} represents a ratio in % of a value in millimoles of phosphorus element contained in the phosphorus compound component (A) to the value in moles of the aromatic dicarboxylate ester,
the reaction products (2) for the catalyst comprises a component (C) reacted with a component (D),
in which reaction products (2),
the component (C) comprises at least one member selected from the group consisting of (c) titanium alkoxides represented by the general formula (I) and (d) reaction products of the titanium alkoxides of the general formula (I) with aromatic polycarboxylic acids represented by the above-mentioned general formula (II) or anhydride of the acids; and 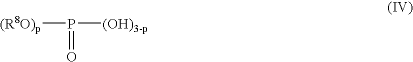
in which formula (IV), R⁸ represents an alkyl group having 1 to 20 carbon atoms or any aryl group having 6 to 20 carbon atoms, and p represents an integer of 1 or 2, and
the multifilament yarn has a thickness of individual filaments of 0.3 to 2.0 dtex, a total thickness of the yarn of 90 dtex or less, and a silk factor (S.F.) value of 22 or more, determined in accordance with the following equation (1):
(S.F.)=(Tensile strength)×(Ultimate elongation)^{1/2} (1).

2. The polyester multifilament yarn as claimed in claim 1, wherein in the component (A) of the mixture (1) for the catalyst, a reaction molar ratio of titanium alkoxide (a) to the aromatic polycarboxylic acid of the general formula (II) or the anhydride thereof is in the range of from 2:1 to 2:5.

3. The polyester multifilament yarn as claimed in claim 1, wherein the dialkyl aromatic dicarboxylate ester is one produced by a transesterification reaction of a dialkyl ester of an aromatic dicarboxylic acid with an alkylene glycol.

4. The polyester multifilament yarn as claimed in claim 3, wherein the aromatic dicarboxylic acid is selected from terephthalic acid, 1,2-naphthalene dicarboxylic acid, phthalic acid, isophthalic acid, diphenyldicarboxylic acid, and diphenoxyethane dicarboxylic acid and the alkylene glycol is selected from ethylene glycol, butylene glycol, trimethylene glycol, propylene glycol, neopentyl glycol, hexamethylene glycol and dodecamethylene glycol.

5. The polyester multifilament yarn as claimed in claim 1, wherein the polyester is a polyethylene terephthalate.

5. The polyester multifilament yarn as claimed in claim 1, wherein the polyester is a polyethylene terephthalate.

6. The polyester multifilament yarn as claimed in claim 1, wherein the polyester polymer has an L* value of 60 to 90 and a b* value of 1 to 10, determined in accordance with the L*a*b* color specification of JIS Z 8729.

7. The polyester multifilament yarn as claimed in claim 1, in the form of a woven or knitted fabric.

8. The polyester multifilament yarn as claimed in claim 2, in the form of a woven or knitted fabric.

9. The polyester multifilament yarn as claimed in claim 3, in the form of a woven or knitted fabric.

10. The polyester multifilament yarn as claimed in claim 4, in the form of a woven or knitted fabric.

11. The polyester multifilament yarn as claimed in claim 5, in the form of a woven or knitted fabric.

12. The polyester multifilament yarn as claimed in claim 6, in the form of a woven or knitted fabric.
